(19) United States
(12) Patent Application Publication
(10) Pub. No.: US 2007/0268230 A1
(43) Pub. Date: Nov. 22, 2007

(54) LEVEL SHIFTER AND LIQUID CRYSTAL DISPLAY USING THE SAME

(76) Inventors: Kee-Chan Park, Anyang-si (KR); Shang-Min Yhee, Seoul (KR); Doo-Hyung Woo, Anyang-si (KR); Zhi Feng Zhan, Yongin-si (KR); Seong-Il Park, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/746,577

(22) Filed: May 9, 2007

(30) Foreign Application Priority Data
May 19, 2006 (KR) 10-2006-0044988

(51) Int. Cl. G09G 3/36

(52) U.S. Cl. 345/100

(57) ABSTRACT

Disclosed is a level shifter having an amplifier amplifying a second supply voltage and generating an input voltage higher than the predetermined signal, a input buffer selectively transferring an input signal based on the input voltage of the amplifier and an output transistor providing a first supply voltage to an output terminal based on the input signal of the input buffer. When the transistor of the amplifier is turned on, the voltage difference of between gate and source of the input buffer is increased according to the increase of the input voltage, so that it is possible to operate with high speed. Moreover, when the transistor of the amplifier is turned off, the voltage difference of between gate and source becomes negative so that power consumption may reduce because there is no leakage current.

### CROSS-REFERENCE TO RELATED APPLICATIONS

This application relies for priority upon Korean Patent Application No. 10-2006-0044988 filed on May 19, 2006, the contents of which are herein incorporated by reference in its entirety.

### BACKGROUND OF THE INVENTION

1. Field of the Invention

This invention relates to a level shifter, and more specifically, to a level shifter for increasing input voltage to drive electrical equipment such as display device.

2. Description of the Related Art

Where a driver, which generates an electric signal for driving a pixel, is integrated with a polycrystalline thin film transistor flat display, it needs to provide high voltage for high speed operation and stable operation of the driver because a thin film transistor of the driver has high threshold voltage and low field effect mobility.

A flat panel display device comprises a liquid crystal display (LCD), a field emission display device (FED), an organic matter emitting light display device (OLED), and a plasma display device (PDP). In general, an active panel display device includes pixels arranged in a matrix form and displays image by controlling the brightness of each pixel according to given image information.

The driver of flat panel display receives a control signal and supply voltage from a signal controller and generates a gate signal and a data signal. The gate signal and the data signal are both provided to each pixel. The control signal and the supply voltage are changed to the level of an input voltage using a level shifter. The level shifter preferably operates with low power consumption and high speed.

### SUMMARY OF THE INVENTION

To achieve the purpose of the present invention in accordance with exemplary embodiments of the present invention, a display device including a level shifter may include a first amplifier for amplifying a first input signal to produce a first amplified input signal, a first input circuit for providing a second input signal in response to the first amplified input signal and a first output circuit for providing a first supply voltage to a first output terminal in response to the second input signal.

The first amplifier further comprises a first capacitor for receiving the first input signal, a first transistor including a first end for receiving a second input voltage and a second end coupled to the first capacitor, The first transistor is a diode-connected transistor and n-type transistor. The first transistor may be made by p-type transistor.

The level shifter may further comprises a second amplifier for amplifying the second input signal to produce an second amplified input signal, a second input circuit for providing the first input signal in response to the second amplified input signal and a second output circuit for providing the first supply voltage to a second output terminal in response to the first input signal.

The second amplifier further comprises a second capacitor for receiving the second input signal, a second transistor including a first end for receiving the second input voltage and a second end coupled to the second capacitor.

The level shifter may further comprises a first output buffer coupled to the first output terminal for generating a first output and a second output buffer coupled to the second output terminal for generating a second output

According to another embodiment, a level shifter may include: a first amplifier having a first node and amplifying a first input signal, a second amplifier having a second node and amplifying a second input signal, a first input buffer receiving the first input voltage and providing a third input voltage to a sixth node, a second input buffer receiving the second input voltage and providing a fourth input voltage to a fifth node, a first output transistor coupled to the first input buffer and transferring a first supply voltage to the first input buffer in response to the fourth input voltage, a second output transistor coupled to the second input buffer and transferring the first supply voltage to the second input buffer in response to the fourth input voltage, a first output buffer coupled to the sixth node and transferring the third input voltage to a first output terminal as a first output signal, and a second output buffer coupled to the fifth node and transferring the fourth input voltage to a second output terminal as a second output signal. The first amplifier may include: a first amplification transistor receiving a second supply voltage and transferring the second supply voltage to the first node, a first capacitor coupled to the first node and generating a first input voltage, and the second amplifier may include: a second amplification transistor receiving the second supply voltage and transferring the second supply voltage to the second node; and a second capacitor coupled to the second node and generating a second input voltage. Each of the first and second buffers includes a first input transistor and second input transistor serially connected.

The first transistor and the second transistor may be commonly controlled by the first input voltage and second input voltage, respectively. The first and second output transistors may p-type transistors. The second input signal is an inversion signal of the first input signal.

### BRIEF DESCRIPTION OF THE DRAWINGS

FIG. 1 is block diagram of liquid crystal display in accordance with one embodiment of this invention.

FIG. 2 is an equivalence circuit diagram of a pixel in liquid crystal display in accordance with one embodiment of this invention.

FIG. 3 is a circuitry of a level shifter of a signal controller in accordance with one embodiment of this invention.

FIG. 4 is another circuitry of level shifter of a signal controller in accordance with the embodiment of this invention.

FIG. 5 is a signal waveform of level shifter of FIG. 3 and FIG. 4 in accordance with the embodiment of this invention.

FIG. 6 is a circuitry of a level shifter of a signal controller in accordance with another embodiment of this invention.

FIG. 7 is another circuitry of a level shifter of signal controller in accordance with another embodiment of this invention.

### DETAILED DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

Embodiments of the invention are described herein with described in detail with reference to the attached drawings. The embodiments of the present invention are only exemplary, and the present invention is not limited thereto.

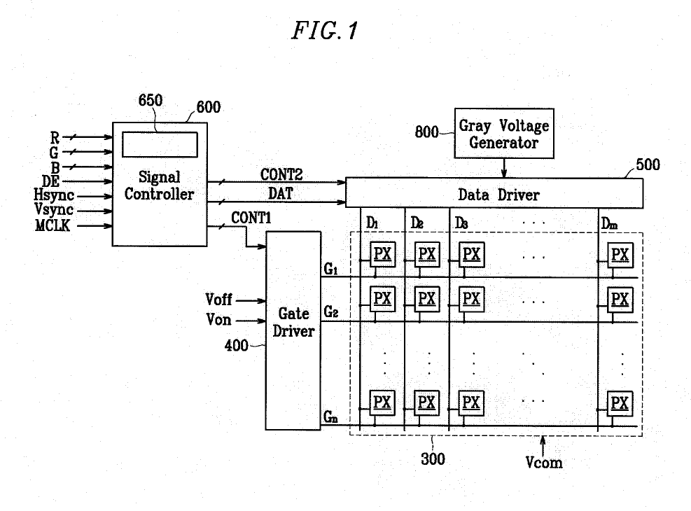

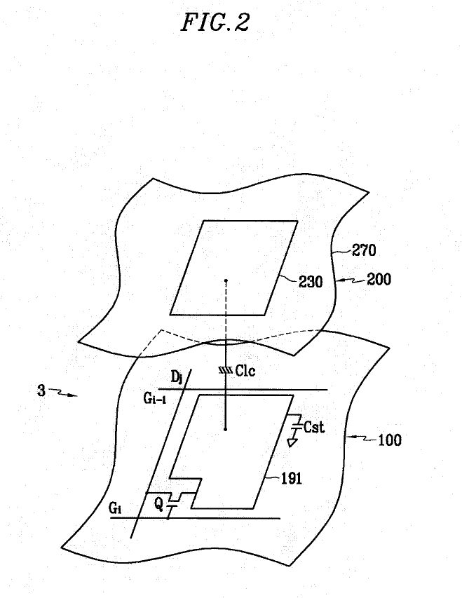

Referring to FIG. 1 and FIG. 2, FIG. 1 is a block diagram of liquid crystal display in accordance with one embodiment of this invention, and FIG. 2 is an equivalence circuit diagram of a pixel in liquid crystal display in accordance with the embodiment of this invention.

A liquid crystal display includes a liquid crystal panel assembly 300, a gate driver 400, a data driver 500, a gray voltage generator 800 and a signal generator 600, in which the gate driver 400 and data driver 500 are coupled to the liquid crystal panel assembly 300 and the data driver 500 is coupled to the gray voltage generator 800. The signal controller 600 controls all of the liquid crystal panel assembly 300, the gate driver 400, the data driver 500, the gray voltage generator 800 and the signal generator 600.

The liquid crystal panel assembly 300 includes pixels connected by signal lines (G1-Gn, D1-Dm) in the form of matrix. As shown in FIG. 2, the liquid crystal panel assembly 300 includes a liquid crystal layer 3 which is interposed between a lower substrate 100 and an upper substrate 200 as opposite to each other.

The signal lines (G1-Gn, D1-Dm) include gate lines (G1-Gn) that transfer gate signals (It is also called Injection signals) and data lines (D1-Dm) that transfer data voltage. The gate lines (G1-Gn) are arranged in row direction, each gate line runs substantially parallel. The data lines (D1-Dm) are arranged in column directions, each data line runs substantially parallel as shown in FIG. 1.

Each pixel PX, for example, the pixel PX includes a switching element Q linked with i'th gate line (i=1, 2, . . . , n) and j'th data line(j=1, 2, . . . , m), a liquid crystal capacitor Clc and a storage capacitor Cst.

The switching element (Q) is a thin film transistor formed on the lower substrate 100 in which a control terminal is connected to the gate line Gi, a input terminal to the data line Di and an output terminal to both of the liquid crystal capacitor Clc and the storage capacitor Cst. Thin film transistor may include polycrystalline silicon or amorphous silicon.

The liquid crystal capacitor Clc includes two electrodes, a pixel electrode 191 in the lower substrate 100 and a common electrode 270 in the upper substrate 200, and the liquid crystal layer 3 functions as a dielectric therebetween. The pixel electrode 191 is coupled to the switching element Q, and the common electrode 270 is formed on the whole surface of upper substrate 200 and receives common voltage Vcom. The common electrode 270 may be formed on the lower substrate 100, wherein the common electrode 270 may be formed by bar shape.

The storage capacitor Cst is formed using insulator positioned between a storage capacitor signal (not shown) and the pixel electrode 191 on the lower substrate 100. The storage capacitor signal may receive a predetermined voltage, such as common voltage Vcom. The storage capacitor Cst may be formed with insulator by overlapping with another gate line.

There are several methods to display colors on the screen of a liquid crystal display. For example, each pixel PX continually displays one of its own primary colors (space division method), or each pixel PX alternatively displays its own primary colors within a predetermined time (time division method) so that the expected colors are displayed on the screen by mixing red, green and blue color. FIG. 2 shows a pixel PX comprising a color filter 230, which faces to the pixel electrode 191, and displaying its own primary color on the upper substrate 200. It can be used in the space division method. The color filter 230 may be formed above or beneath the pixel electrode 191 on the lower substrate 100.

At least one polarizer (not shown) polarizing light is formed on out surface of the liquid crystal panel assembly 300.

Referring to FIG. 1, the gray voltage generator 800 generates two sets of gray voltage (or, a reference voltage set) for applying them to the pixel PX. One set has a positive voltage and the other set has a negative voltage on the basis of the common voltage Vcom.

Gate driver 400 is coupled to the gate lines G1-Gn in the liquid crystal panel assembly 300 and applies a gate turn-on voltage Von and a gate turn-off voltage Voff to the gate lines (G1-Gn) as gate signals.

Data driver 500 is coupled to the data lines (D1-Dm) in the liquid crystal dial panel assembly 300 and selects gray voltages from the gray voltage generator 800, and thereafter applies them to the data lines (D1-Dm) as a data voltage.

Signal controller 600 controls the gate driver 400 and the data driver 500. The signal controller 600 includes a level shifter 650 which generates an output signal by transforming the voltage level of the input signal.

The gate driver 400, data driver 500, signal controller 600 and gray voltage generator 800 may be formed on the liquid crystal panel assembly 300. The liquid crystal panel assembly 300 includes gate signals G1-Gn, data signals D1-Dm and thin film transistor switching elements Q. Moreover, the driver 400, data driver 500, signal controller 600 and gray voltage generator 800 may be formed on the liquid crystal panel assembly 300 in the form of integrated circuit or in the form of tape carrier package (TCP) attached on a flexible printed circuit film (not shown). A printed circuit board (not shown) may be used for attaching the drivers.

The gate driver 400, data driver 500, signal controller 600 and gray voltage generator 800 may be manufactured as a single chip. One of the gate driver 400, data driver 500, signal controller 600 and gray voltage generator 800 can be formed outside of the chip.

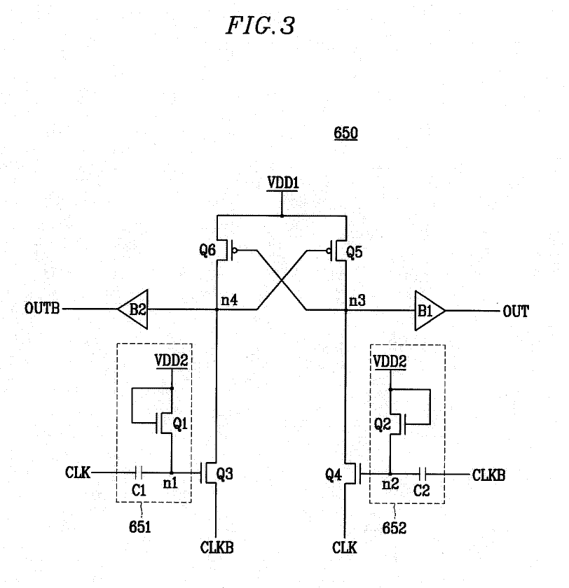

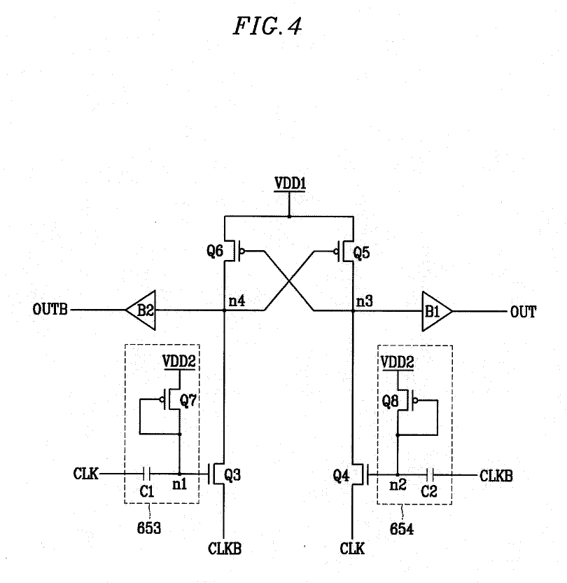

Referring to FIG. 3 to FIG. 7, the level shifter 650 is explained more detail. FIG. 3 is one circuitry of a level shifter in a signal controller and FIG. 4 is another circuitry of a level shifter in a signal controller according to one embodiment of this invention.

In FIG. 3, the level shifter 650 includes a pair of amplifier 651, 652, a pair of input transistor Q3, Q4, a pair of output transistor Q5, Q6 and a pair of buffer B1, B2. The first amplifier 651 receiving a second supply voltage VDD2 includes a first capacitor C1 and a first transistor Q1. An output voltage of the first transistor Q1 is amplified in response to a first input signal CLK. The amplified output voltage is provided to a third transistor Q3.

The second amplifier 652 receiving the supply voltage VDD2 includes a second capacitor C2 and a second transistor Q2. An output voltage of the second transistor Q2 is amplified in response to a second input signal CLKB. The amplified output voltage is provided to a third transistor Q4. Both of the first input signal CLK and the second input signal CLKB may have inverse phase.

The first and second transistors Q1, Q2 are n-type transistors. Each transistor includes a control terminal, an input terminal and an output terminal. The control terminal and input terminal are coupled to second supply voltage VDD2, and the output terminal is couple to a first node n1 or a second node n2. The first capacitor C1 is formed between the first node n1 and the first input signal CLK and the second capacitor C2 is formed between the second node n2 and the second input signal CLKB. Third transistor Q3 and sixth transistor Q6 are serially connected between the second input signal CLKB and a first supply voltage VDD1. Fourth transistor Q4 and sixth transistor Q5 are serially connected between the first input signal CLK and the first supply voltage VDD1.

Third and fourth transistors Q3, Q4 are n-type transistors. Each transistor includes a control terminal, an input terminal and an output terminal. In third transistor Q3, the control terminal is connected to a first node n1, the input terminal is coupled to the second input signal CLKB and the output terminal is connected to the sixth transistor Q6. In fourth transistor Q4, the control terminal is connected to a second node n2, the input terminal is coupled to the first input signal CLK and an output terminal is connected to the fifth transistor Q5. The fifth and sixth transistors Q5, Q6 are p-type transistors. Each transistor includes a control terminal, an input terminal and an output terminal The third node n3 is coupled to the control terminal of sixth transistor Q6 and the output terminal of fifth transistor Q5. The fourth node n4 is coupled to the control terminal of fifth transistor Q5 and the output terminal of sixth transistor Q6. Input terminal of each transistor Q5, Q6 is coupled to the first supply voltage VDD1.

Buffers B1 and B2 are connected to third and fourth node n3 and n4, respectively and generate an output signal of level shifter 650. Though buffers B1 and B2 are used for stabilizing a first and second output signals OUT, OUTB, the level shifter 650 may be used without the buffers B1, B2.

In FIG. 4, a third amplifier 653 receiving a second supply voltage VDD2 includes a seventh transistor Q7 and a first capacitor C1. A fourth amplifier 654 receiving the second supply voltage VDD2 includes an eighth transistor Q8 and a second capacitor C2. Each transistor is a p-type transistor and includes an input terminal, a control terminal and an output terminal. The output terminal of the transistors Q7 is coupled to a first node n1 and the output terminal of the transistors Q8 is coupled to a second node n2.

Because all figures of FIG. 4 have same configuration with FIG. 3 without a third amplifier 653 and a fourth amplifier 654, the other drawings of FIG. 4 will not be described in detail.

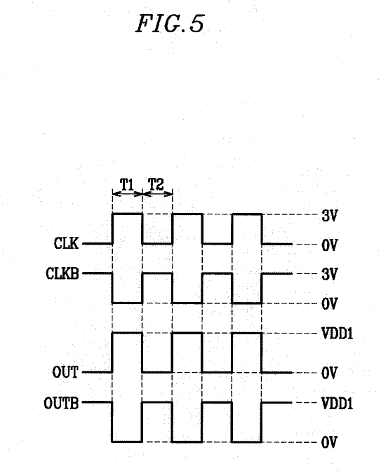

As shown in FIG. 3 and FIG. 5, the operation of the level shifter 650 is explained as below.

A first input signal CLK is a clock signal having high voltage 3V and low voltage 0V, alternatively, and a second input signal CLKB is an inversion clock signal of the first input signal CLK. Assume that a first supply voltage VDD1 is 5V, a second supply voltage VDD2 is 3V, and a threshold voltage of an transistor Q1 or Q2 is 1V. The threshold voltage may have different values. A diode-connected transistor Q1 of the first amplifier 651 supplies 2V to a first node n1 because the threshold voltage of transistor Q1 is 1 V.

During the first period T1, the first input signal CLK varies from 0V to 3V and therefore the second input signal CLKB inversely varies from 3V to 0V. Therefore, the voltage of the first node n1 varies up to 5V according to the first input signal CLK having 3V. Then, transistor Q3 turns on and transmits 0V to a fourth node n4 based on the second input signal CLKB having 0V. Accordingly, transistor Q5 turns on and transmits the first supply voltage VDD1 to a third node n3.

Similarly, a diode-connected transistor Q2 of the first amplifier 652 supplies 2V to a second node n2 because the threshold voltage of transistor Q2 is 1 V.

As the first input signal CLK becomes 3V and the second input signal CLKB becomes 0V, the second node n2 of the second amplifier 652 has previous voltage level 2V. Moreover, because the third node n3 has 5 v and first input signal CLK has 3V, the transistor Q4 has a negative gate to source voltage Vgs. Then, the transistor Q4 is turned off. Therefore, a third node n3 has kept 5V to be the same as the first supply voltage VDD1 and transistor Q6 is turned off. Therefore, the voltage of the fourth node n4 is kept stably by 0V.

As a result, buffers B1 and B2 provide 5and 0V, respectively, to a gate driver 500 or a data driver 500 as a first and second output signals OUT, OUTB. The level shifter is formed in the signal controller 600 and generates a stable voltage such as output signals OUT and OUTB.

During the second period T2, the first amplifier 651 and the second amplifier 652 operate reversely, as compared to the operation of first period T1 and therefore the first output signal OUT is 0V and the second output signal OUTB is 5V.

By using input signals CLK and CLKB, as input voltage provided from amplifiers 651 and 652 of the level shifter 650 is increased, the resistance of each transistor Q3, Q4 becomes low so that high speed operation can achieve. When the transistors Q3 and Q4 are turned off, current consumption is reduced because there is no leakage current between gate and source based on negative voltage of its gate to source voltage Vgs.

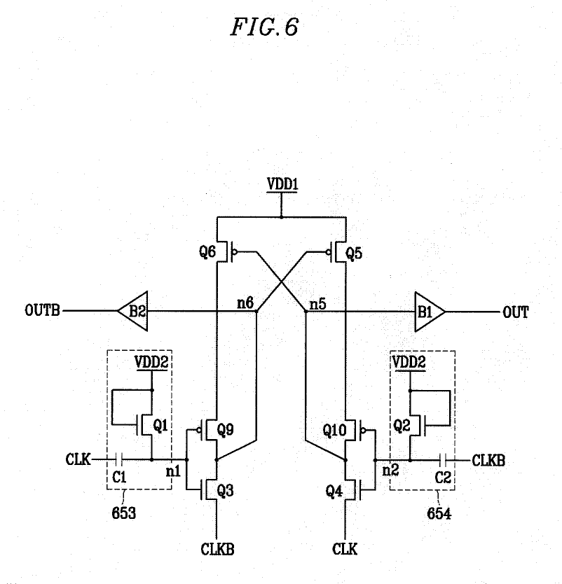

FIG. 6 is another circuit of a level shifter in a signal controller according to this invention.

In FIG. 6, a level shifter 650 includes a pair of amplifiers 651, 652, a pair of transistors Q3 and Q4, a pair of transistors Q9 and Q10, a pair of transistors Q5 and Q6 and a pair of buffers B1 and B2 with symmetry, respectively.

The first amplifier 651 includes a transistor Q1 and a capacitor C1. The second amplifier 651 includes a transistor Q2 and a capacitor C2. Because the first and second amplifiers 651 and 652 have the same configuration as FIG. 3, detailed description for the first and second amplifier will not be showed. Referring to FIG. 6, a transistor Q3, a transistor Q9 and a transistor Q6 are serially connected between a second input signal CLKB and a first supply voltage VDD1. Similarly, a transistor Q4, a transistor Q10 and a transistor Q5 are serially connected between first input signal CLK and the first supply voltage VDD1.

The transistors Q3 is an n-type transistor and includes a control terminal coupled to first node n1, an input terminal coupled to a second clock signal CLKB and an output terminal coupled to a sixth node n6. The transistors Q4 is also an n-type transistor and includes a control terminal coupled to second node n2, an input terminal coupled to a first clock signal CLK and an output terminal coupled to a fifth node n5.

The transistor Q9 is a p-type transistor and includes a control terminal coupled to first node n1, an input terminal coupled to the output transistor Q6 and an output terminal coupled to a sixth node n6. The transistor Q10 is a p-type transistor and includes a control terminal coupled to second node n2, an input terminal coupled to the transistor Q5 and an output terminal coupled to a fifth node n5.

The transistor Q6 is a p-type transistor and includes a control terminal coupled to fifth node n5, an input terminal coupled to first supply voltage VDD1, and output terminal coupled to transistor Q9. The transistor Q5 is a p-type transistor and includes a control terminal coupled to sixth node n6, an input terminal coupled to second supply voltage VDD2 and an output terminal coupled to transistor Q10.

The control terminals of transistor Q3 and Q9 are commonly connected with a first node n1. The control terminals of transistors Q10 and Q4 are also commonly connected with a second node n2. Each drain of the transistors Q3 and Q4 is coupled to the second and the first input signals CLKB and CLK, The sources of the transistors Q9 and Q3 are coupled to the transistors Q5 and Q6, respectively. The sixth node n6 is commonly coupled to the source of transistor Q3 and the drain of transistor Q9. The fifth node n5 is commonly coupled to the source of transistor Q4 and the drain of transistor Q10.

Buffers B1, B2 are coupled to a fifth node n5 and sixth node n6, respectively.

Referring to FIG. 5, FIG. 6, the operation of the level shifter 650 is as follows. Assume the first supply voltage VDD1 is 7V and the voltage of other parts is same level as shown in FIG. 3.

During the first period T1, a capacitor C1 stores 2V provided from a diode connected transistor of first amplifier 651. As the first input signal CLK rises up to 3V and the second input signal CLKB falls to 0V, a capacitor C1 is charged up from 2V to 5V. As a result, a transistor Q3 is turned on and the level of the sixth node n6 goes to 0V based on the second input signal CLKB.

Furthermore, transistor Q5 is turned on and provides the first supply voltage VDD1 by 7V to an input terminal of transistor Q10.

In the second amplifier 652, as a first input signal CLK becomes 3V and a second input signal CLKB becomes 0V, the second node n2 preserves previous voltage 2V which is the level transferred from a diode connected transistor Q2. Therefore, each of gate to source voltages Vgs in a transistor Q10 and a transistor Q4 becomes −5V. Therefore, a transistor Q10 is turned on and the transistor Q4 is turned off. Finally, the first supply voltage VDD1 is transferred to fifth node n5 up to 7V through the transistor Q5 and transistor Q10.

Then, transistor Q6 is turned off and a sixth node n6 is stabilized by 0V transferred as the second input signal CLKB from input transistor Q3 because transistor Q9 does not flow electric current.

Though a transistor Q6 does not turn off in the beginning of operation so that the transistor Q6 provides the first supply voltage VDD1 to a transistor Q9, the fifth node5 is stabilized by 0V provided from transistor Q3. The reason is that transistor Q9 has weak inversion in the channel layer as compared to transistor Q3 because a gate to source voltages Vgs of transistors Q3 and Q9 are 5V and −2V, respectively.

Buffer B1 transfers 7V of fifth node n5 to a gate driver 400 and a data driver 500 as a first output signal OUT. Buffer B2 transfers 0V of sixth node n6 to a gate driver 400 and a data driver 500 as a second output signal OUTB.

During period T2, as opposite to the first period, the first output signal OUT becomes 0V and the second output signal OUTB becomes 7V. As described above, in order to increase the level of output signals OUT, OUTB, the first supply voltage VDD1 should be increased and a transistor Q9 should be placed between input transistor Q3 and output transistor Q6.

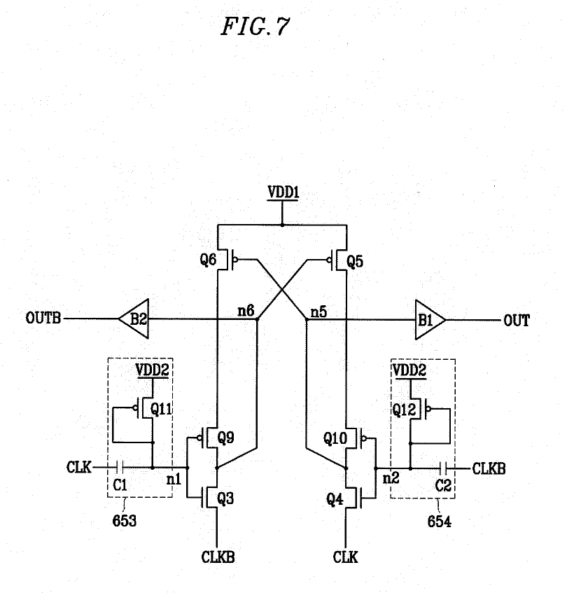

In FIG. 7, all figures are same with FIG. 6 without third amplifier 653 and fourth amplifier 654.

The operation of the amplifiers 653, 654 is similarly explained in FIG, 4, so the operation of the amplifiers will not be explained in detail.

According to the operation of liquid crystal display, signal controller 600 receives input video signals (R, G, B) and input control signal, in which the input control signal controls their displaying based on external graphic controller (not shown). Input video signals (R, G, B) contain luminance information of each pixel PX and the luminance information includes grays, such as 1024(=2¹⁰), 256(=2⁸) or 64(=2⁶) grays. Examples of input control signal are a vertical sync signal Vsync, a horizontal synchronization signal Hsync, a main clock MCLK and a data enable signal DE.

After signal controller 600 applies input video signals R, G, B on liquid crystal display panel 300 and generates a gate control signal CONT1 and a data control signal CONT2, it provides the gate control signal CONT1 to a gate controller 400 and provides a data control signal CONT2 and image data DATA to a data driver 500.

Gate control signal CONT1 includes a start signal STV that informs that operation starts, and at least one clock signal that controls output cycle of gate on voltage Von. Gate control signal CONT1 may include output enable signal OE that limits the duration time of gate on voltage Von.

Data control signal CONT2 includes a horizontal synchronization start signal STH, a load signal LOAD and a data clock signal HCLK. Wherein the horizontal synchronization start signal STH indicates that digital video signal DAT for pixel PX begins to transmit, and both a load signal LOAD and a data clock signal HCLK indicate that analog data voltage applies to data lines D1˜Dm. The data control signal CONT2 may further include an inversion signal RVS for reversing the polarity of analog data voltage for a common voltage Vcom.

According to the data control signal CONT2 of signal controller 600, data driver 500 receives a digital video signal DAT for one row of pixels and selects a gray voltage for each digital video signal DAT. Thus, after a digital video signal DAT is converted to an analog data voltage, it is applied to data lines D1˜Dm.

Gate driver 400 turns on a switching element Q coupled to gate lines G1˜Gn by applying gate on voltage Von in responsive to a gate control signal CONT1 of a signal controller 600.

A data voltage applied to a pixel PX is stored in a liquid crystal capacitor Clc as a pixel voltage which is a voltage difference between the data voltage and common voltage Vcom. According to the magnitude of the pixel voltage, liquid crystal molecules are differently arranged. Therefore, a polarized light passing through a liquid crystal layer 3 is varied based on their arrangement. The variation of polarized light is appeared as the variation of transmittance ratio of light. By this variation, each pixel PX displays its brightness having in a gray of a video signal DAT.

The one horizontal cycle of the above process is repeatedly operated. The one horizontal cycle is described as “1H” and has the same period as the one period of horizontal synchronization signal Hsync and a data enable signal DE. The image of one frame is displayed on screen by sequentially applying gate on voltage Von to all gate lines G1˜Gn and applying data voltage to all pixels PX.

If one frame ends and next frame starts, the polarity of data voltage applied to each pixel PX is controlled in order to have opposite polarity of previous frame in responsive to an inversion signal RVS applying to a data driver 500. It is referred as a frame inversion.

According to the characteristic of inversion signal RVS, the polarity of voltage applied to one data line or one pixel may be changed, which is a line (row or column) inversion or dot inversion,

According to the embodiment of present invention, the level shifter 650 may be applicable to other flat panel displays including organic light emitting display device as well as liquid crystal display or electrical equipment.

According to this invention, it is possible to operate the level shifter at high speed because gate to source voltage Vgs is increased. It is achieved by raising the input voltage by using input signal.

While the embodiments of the present invention have been described using specific terms, such description is for illustrative purposes only, and it is to be understood that changes and variations may be made without departing from the spirit or scope of the following claims.

What is claimed is:

1. A level shifter comprising:
a first amplifier for amplifying a first input signal to produce a first amplified input signal;
a first input circuit for providing a second input signal in response to the first amplified input signal; and
a first output circuit for providing a first supply voltage to a first output terminal in response to the second input signal.

2. A level shifter according to claim 1, wherein the first amplifier further comprises,
a first capacitor for receiving the first input signal; a first transistor including a first end for receiving a second input voltage and a second end coupled to the first capacitor;

3. A level shifter according to claim 2, wherein the first transistor is a diode-connected transistor.

4. A level shifter according to claim 3, wherein the diode-connected transistor is an n-type transistor.

5. A level shifter according to claim 3, wherein the diode-connected transistor is a p-type transistor.

6. A level shifter according to claim 1 further comprising:
a second amplifier for amplifying the second input signal to produce an second amplified input signal;
a second input circuit for providing the first input signal in response to the second amplified input signal; and
a second output circuit for providing the first supply voltage to a second output terminal in response to the first input signal.

7. A level shifter according to claim 6, wherein the second amplifier further comprising:
a second capacitor for receiving the second input signal;
a second transistor including a first end for receiving the second input voltage and a second end coupled to the second capacitor.

8. A level shifter according to claim 6 further comprising:
a first output buffer coupled to the first output terminal for generating a first output;
a second output buffer coupled to the second output terminal for generating a second output

9. A level shifter comprising:
a first amplifier having a first node and amplifying a first input signal;
a second amplifier having a second node and amplifying a second input signal;
a first input buffer receiving the first input voltage and providing a third input voltage to a sixth node;
a second input buffer receiving the second input voltage and providing a fourth input voltage to a fifth node;
a first output transistor coupled to the first input buffer and transferring a first supply voltage to the first input buffer in response to the fourth input voltage;
a second output transistor coupled to the second input buffer and transferring the first supply voltage to the second input buffer in response to the fourth input voltage;
a first output buffer coupled to the sixth node and transferring the third input voltage to a first output terminal as a first output signal; and
a second output buffer coupled to the fifth node and transferring the fourth input voltage to a second output terminal as a second output signal.

10. A level shifter according to claim 9, wherein the first amplifier further comprises,
a first amplification transistor receiving a second supply voltage and transferring the second supply voltage to the first node and;
a first capacitor coupled to the first node and generating a first input voltage; and
wherein the second amplifier further comprises,
a second amplification transistor receiving the second supply voltage and transferring the second supply voltage to the second node; and
a second capacitor coupled to the second node and generating a second input voltage.

11. A level shifter according to claim 10, wherein each of the first and second buffers comprises a first input transistor and second input transistor serially connected.

12. A level shifter according to claim 11, wherein the first input transistor is a p-type transistor and the second input transistor is an n-type transistor.

13. A level shifter according to claim 11, wherein each of the second input transistors receives a reverse phase signal.

14. A level shifter according to claim 10, wherein the first input transistor and the second output transistor of the first input buffer and second input buffer are commonly controlled by the first input voltage and second input voltage, respectively.

15. A level shifter according to claim 9, wherein the first and second output transistors are p-type transistors.

16. A level shifter according to claim 9, wherein the second input signal is an inversion signal of the first input signal.

17. A liquid crystal display device comprising:
a plurality of pixel coupled to a gate line and a data line;
a gate driver for providing a gate signal to the gate line;
a data driver for providing a data signal to the data line; and
a signal generator including a level shifter for driving the gate driver,
wherein, the level shifter further comprises;
a first amplifier for amplifying a first input signal to produce a first amplified input signal;
a first input circuit for providing a second input signal in response to the first amplified input signal; and
a first output circuit for providing a first supply voltage to a first output terminal in response to the second input signal.

18. A level shifter according to claim 17, wherein the first amplifier further comprises,
a first capacitor for receiving the first input signal;
a first transistor including a first end for receiving a second input voltage and a second end coupled to the first capacitor;

19. A level shifter according to claim 17 further comprising:
a second amplifier for amplifying the second input signal to produce an second amplified input signal;
a second input circuit for providing the first input signal in response to the second amplified input signal; and
a second output circuit for providing the first supply voltage to a second output terminal in response to the first input signal.

20. A level shifter according to claim 19, wherein the second amplifier further comprising:
a second capacitor for receiving the second input signal; and
a second transistor including a first end for receiving the second input voltage and a second end coupled to the second capacitor.
